(19) United States
(12) Patent Application Publication
(10) Pub. No.: US 2025/0347549 A1
(43) Pub. Date: Nov. 13, 2025

(54) RETRACTABLE MULTI-SHAPED SCALE

(71) Applicants: Fu Jen Catholic University Hospital, Fu Jen Catholic University, New Taipei City (TW); Easton Precision Industries Corp., New Taipei City (TW)

(72) Inventors: HAN-SUN CHIANG, New Taipei City (TW); CHING-CHUAN JIANG, New Taipei City (TW); PO-JUI YU, New Taipei City (TW); HEN-LIANG LIN, New Taipei City (TW); MEI-CHIEH LI, New Taipei City (TW); CHIA-JUNG TSAI, New Taipei City (TW); YEN-CHUN KUO, New Taipei City (TW); KUN-MU CHENG, New Taipei City (TW); AN-AN CHENG, New Taipei City (TW); WEI-CHUNG CHENG, New Taipei City (TW); YONG-JUN LIU, New Taipei City (TW)

(21) Appl. No.: 18/769,824

(22) Filed: Jul. 11, 2024

(30) Foreign Application Priority Data
May 8, 2024 (TW) 113117089

(51) Int. Cl. G01G 19/44; G01G 21/22; G01G 21/23

(52) U.S. Cl. CPC G01G 19/445; G01G 21/22; G01G 21/23

(57) ABSTRACT

A retractable multi-shaped scale comprises a retractable part consisting of a fixed platform, a first retractable platform, a second retractable platform, a support part for supporting and transmitting weight. The support part includes multiple support frames, with one end pivotally attached to the lower edge of the fixed platform and the other end pivotally attached to a base located at the bottom of the scale. The base contains at least one weight sensor to obtain measurement results. a telescopic rod, with one end pivotally attached to the base and the other end pivotally attached to the support part, is used to drive the support frames from a horizontal to a vertical position, further adjusting the distance between the base and the retractable part. An operation panel is connected to the weight sensor to display the measurement results obtained by the weight sensor.

### CROSS-REFERENCE TO RELATED APPLICATIONS

This non-provisional application claims priority under 35 U.S.C. § 119 on Patent Application No. TW113117089 filed in Taiwan, Republic of China May 8, 2024, the entire contents of which are hereby incorporated by reference in its entirety.

### FIELD OF THE INVENTION

The present invention relates generally to a scale for measuring body weight, and more particularly to a retractable multi-shaped scale.

### BACKGROUND OF INVENTION

The commonly used weight measurement devices in hospitals include upright height and weight scales, bed scales, bed crane scales, seat scales, and floor scales. These weight measurement devices have distinct applicable situations and objects. The equipment such as bed crane scales, seat scales or floor scales are relatively large and require a certain space, and would limit or affect the space for other equipment in the same ward area.

The existing multi-functional weight scales have many deficiencies, such as too heavy, too complicated transformation of shapes, and inconvenient transformation of shapes.

Therefore, there is an urgent need for a scale that is smaller and more convenient and free from installing or removing additional components.

### SUMMARY OF THE INVENTION

The purpose of the present invention is to provide a retractable multi-shaped scale that allows the user to change the scale into various shapes with simple operations.
a retractable multi-shaped scale includes a retractable part, the retractable part 1 includes a fixed platform, two opposite sides of the fixed platform are provided with a first rail and a second rail respectively, the first rail is parallel to the second rail; a first retractable platform, the first retractable platform can accommodate the fixed platform, and can slide along one of the non-rail sides through the first rail; a second retractable platform, the second retractable platform can accommodate the first retractable platform, and can slide toward the opposite side of the extension direction of the first retractable platform through the second rail; a first driving member, installed inside the fixed platform, the first driving member can extend or retract the first retractable platform and the second retractable platform; a support part, for supporting the retractable part and conducting weight, the support part includes a first support component, the first support component includes a plurality of support frames and a cross bar; a second support component, the second support component includes the support frames, one end of the support frames is pivotally connected to the bottom of the fixed platform of the retractable part; a base, located at the lower part of the scale, the other end of the support frames is pivotally connected to the base, the base includes at least one weight sensor, for obtaining the measurement results; a telescopic rod, one end of the telescopic rod is pivotally connected to the base, and the other end is pivotally connected to the cross bar of the first support component, for driving the support part from standing height (horizontal to vertical), so as to change the distance between the base and the retractable part, the telescopic rod is driven by a second driving member; and an operation panel, the operation panel is connected to the first driving member, the second driving member and the weight sensor, on which the extension length of the telescopic rod can be set and the measurement results of the weight sensor can be displayed.

A way to use retractable multi-shaped scale, includes a user chooses a lying position on an operation panel, the operation panel sends signals to inform the first driving member to extend a first retractable platform and a second retractable platform to both sides of a fixed platform. The operation panel sends signals to inform a second driving member to extend a telescopic rod to the set length for the lying position, so that the retractable part is as high as the bed (for example, 50˜60 cm). a telescopic handle frame is parallel to the retractable part and fixed with a knob, and the user can push the telescopic handle frame to move the scale to a subject. The plurality of rollers of the base are fixed, so that the scale is stably fixed on the ground. The user moves the subject to the retractable part of the scale, the retractable part transmits the subject's weight to at least one weight sensor of the base, and the weight sensor transmits the sensed weight to the operation panel.

The retractable multi-shaped scale provided by the present invention can change its form to accommodate different situations, allowing users to measure weight in various positions such as sitting, lying down, or standing. It offers users a convenient way to switch between different types of weighing scales. For hospitals, there is no need to purchase separate equipment like bed scales, chair scales, or standing scales simultaneously. This invention also avoids restricting the placement space for other equipment in the same ward area. Additionally, the retractable multi-shaped scale can reduce its size for easy storage and mobility, minimizing user inconvenience.

### BRIEF DESCRIPTION OF THE DRAWINGS

FIG. 1 Diagram illustrating the schematic diagram of retractable multi-shaped scale.

FIG. 2 Diagram illustrating the schematic diagram of the retractable multi-shaped scale in the lying position.

FIG. 3 Diagram illustrating the structure of the retractable part and support part, including the telescopic rod.

FIG. 4 Diagram illustrating the structure of the retractable part's backside and the base.

FIG. 5 Diagram illustrating the standing position and sitting position of the retractable multi-shaped scale.

FIG. 6 Diagram illustrating the operational state of the retractable multi-shaped scale.

FIG. 7 The operational procedure for using the retractable multi-shaped scale in the standing position.

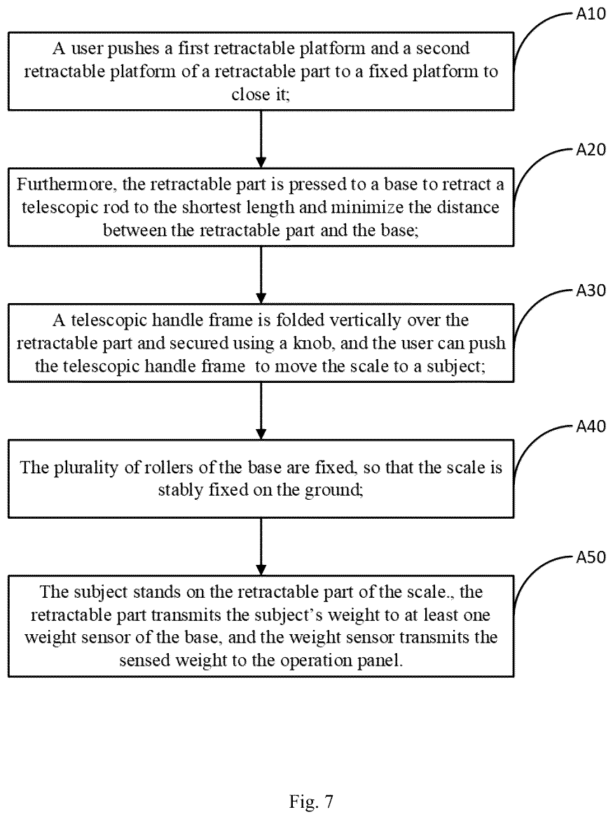

FIG. 8 The operational procedure for using the retractable multi-shaped scale in the sitting position.

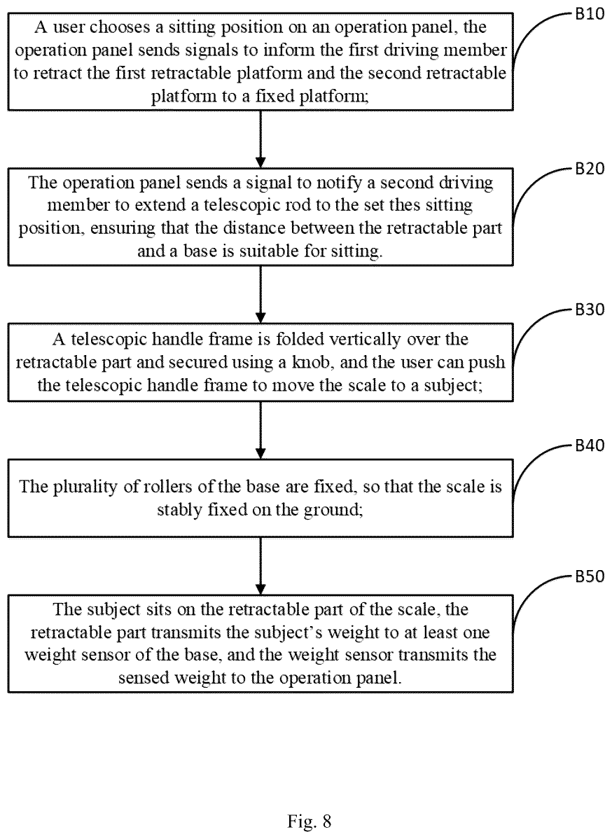

FIG. 9 The operational procedure for using the retractable multi-shaped scale in the lying position.

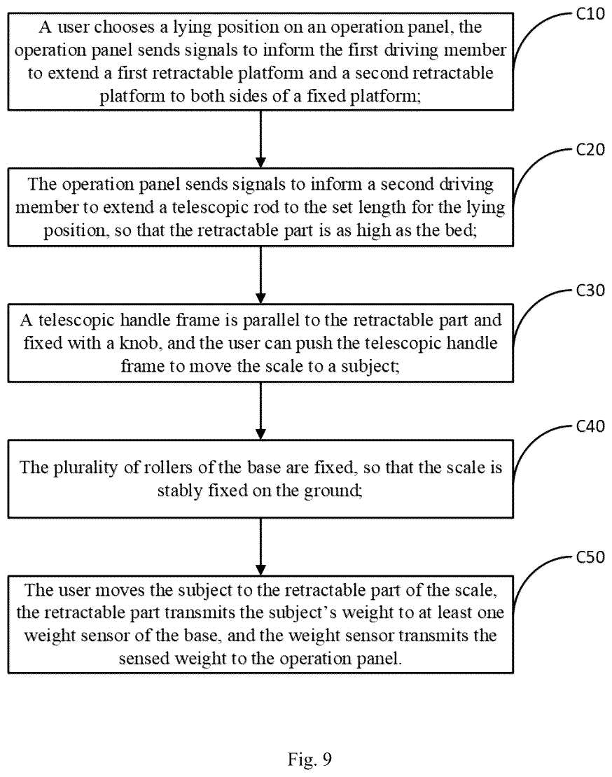

### DETAILED DESCRIPTION OF THE INVENTION

Below, multiple embodiments of the present invention will be disclosed in diagram form. For the sake of clarity, many practical details will be explained in the following description. However, it should be understood that these practical details should not be used to limit the scope of the present invention. Furthermore, for the purpose of simplifying the diagrams, some commonly used structures and components will be depicted in a simplified and schematic manner.

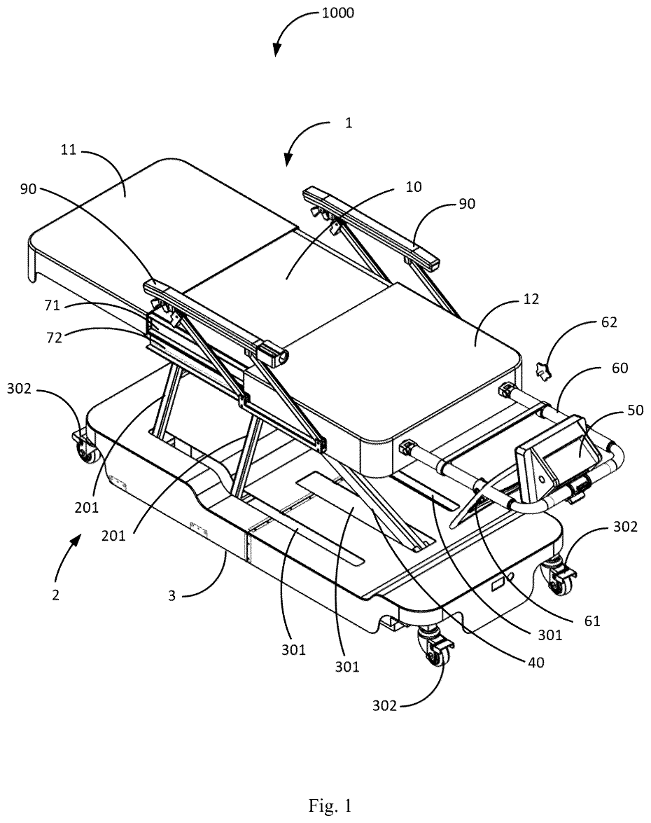

In this document, terms such as “first” or “second” and similar ordinal numbers are used to distinguish or refer to related or similar components or structures. It is not necessarily implied that these components, structures, parts, or areas have a specific spatial order. It should be understood that in certain situations or configurations, ordinal numbers can be used interchangeably without affecting the implementation of the present invention.
a retractable multi-shaped scale 1000, as shown in FIG. 1 to FIG. 4, includes: a retractable part 1, the retractable part 1 includes: a fixed platform 10, two opposite sides of the fixed platform 10 are provided with a first rail 71 and a second rail 72 respectively, the first rail 71 is parallel to the second rail 72; a first retractable platform 11, the first retractable platform 11 can accommodate the fixed platform 10, and can slide along one of the non-rail sides through the first rail 71; a second retractable platform 12, the second retractable platform 12 can accommodate the first retractable platform 11, and can slide toward the opposite side of the extension direction of the first retractable platform 11 through the second rail 72; a first driving member 81, installed inside the fixed platform 10, the first driving member 81 can extend or retract the first retractable platform 11 and the second retractable platform 12; a support part 2, for supporting the retractable part 1 and conducting weight, the support part 2 includes: a first support component 21, the first support component 21 includes a plurality of support frames 201 and a cross bar 202; a second support component 22, the second support component 22 includes the support frames 201, one end of the support frames 201 is pivotally connected to the bottom of the fixed platform 10 of the retractable part 1; a base 3, located at the lower part of the scale, the other end of the support frames 201 is pivotally connected to the base 3, the base 3 includes: at least one weight sensor 31, for obtaining the measurement results; a telescopic rod 40, one end of the telescopic rod 40 is pivotally connected to the base 3, and the other end is pivotally connected to the cross bar 202 of the first support component 21, for driving the support part 2 from standing height (horizontal to vertical), so as to change the distance between the base 3 and the retractable part 1, the telescopic rod 40 is driven by a second driving member 82; and an operation panel 50, the operation panel 50 is connected to the first driving member 81, the second driving member 82 and the weight sensor 31, on which the extension length of the telescopic rod 40 can be set and the measurement results of the weight sensor 31 can be displayed.

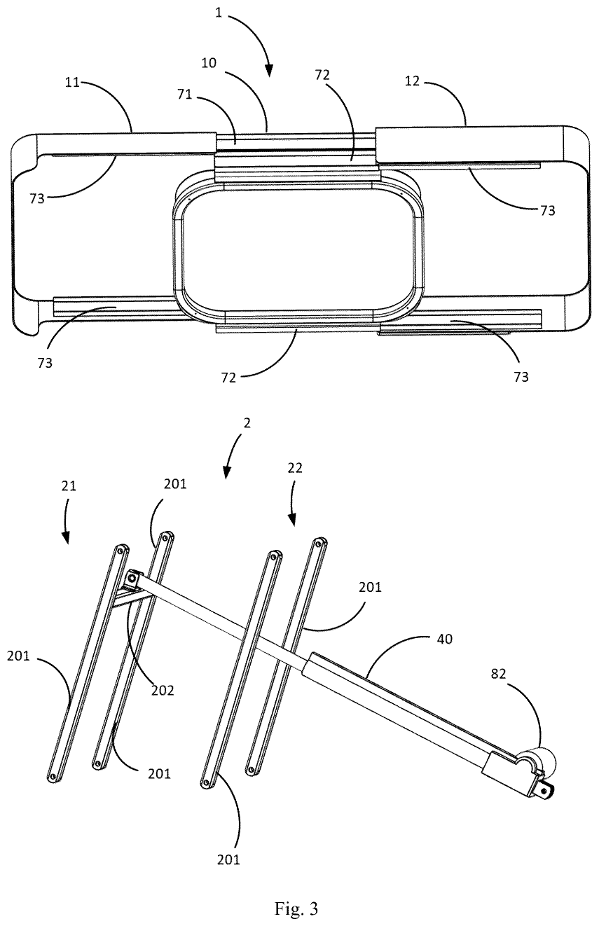

Both ends of the cross bar 202 are connected to the support frame 201 of the first support component 21 respectively, and one end of the telescopic rod 40 is pivoted at the center of the cross bar 202, as shown in FIG. 3.

The second support component 22 includes the cross bar 202, both ends of the cross bar 202 are connected to the support frame 201 of the second support component 22 respectively, and one end of the telescopic rod 40 is pivoted at the center of the cross bar 202, the other end is pivotally connected to the base 3.

The telescopic rod 40 includes a first telescopic rod and a second telescopic rod. One end of the first telescopic rod is pivotally connected to the base 3, and the other end is pivotally connected to the cross bar 202 of the first support component 21. One end of the second telescopic rod is pivotally connected to the base 3, and the other end is pivotally connected to the cross bar 202 of the second support component 22.

The first telescopic rod and the second telescopic rod of the telescopic rod 40 are simultaneously pivotally connected to the cross bar 202 of the second support component 22 or the cross bar 202 of the first support component 21.

The first telescopic rod of the telescopic rod 40 is pivotally connected to one of the support frames 201 of the second support component 22 or the first support component 21, the second telescopic rod is pivotally connected to the other support frame 201 of the support frames 201 of the second support component 22 or the first support component 21.

The telescopic rod 40 can change the distance between the retractable part 1 and the base 3, meaning the overall height of the retractable multi-shaped scale 1000 can be adjusted.

The telescopic rod 40 can be a pneumatic rod, a hydraulic rod or a screw rod, as long as it is a component that can drive the support part 2 to rise and fall, and the invention is not limited thereto.

The base 3 also includes a plurality of rollers 302, which are distributed under the base 3, allowing the retractable multi-shaped scale 1000 to be easily moved to the person to be weighed.

As shown in FIG. 3, the inner space of the first retractable platform 11 is slightly larger than the size of the fixed platform 10. Two inner sides of the first retractable platform 11 corresponding to the first rail 71 of the fixed platform 10 are provided with a slide rail 73. The first retractable platform 11 can slide along the first rail 71. The inner space of the second retractable platform 12 is slightly larger than the size of the first retractable platform 11. Two inner sides of the second retractable platform 12 corresponding to the second rail 72 of the fixed platform 10 are provided with the slide rail 73, and the second retractable platform 12 can slide along the second rail 72.

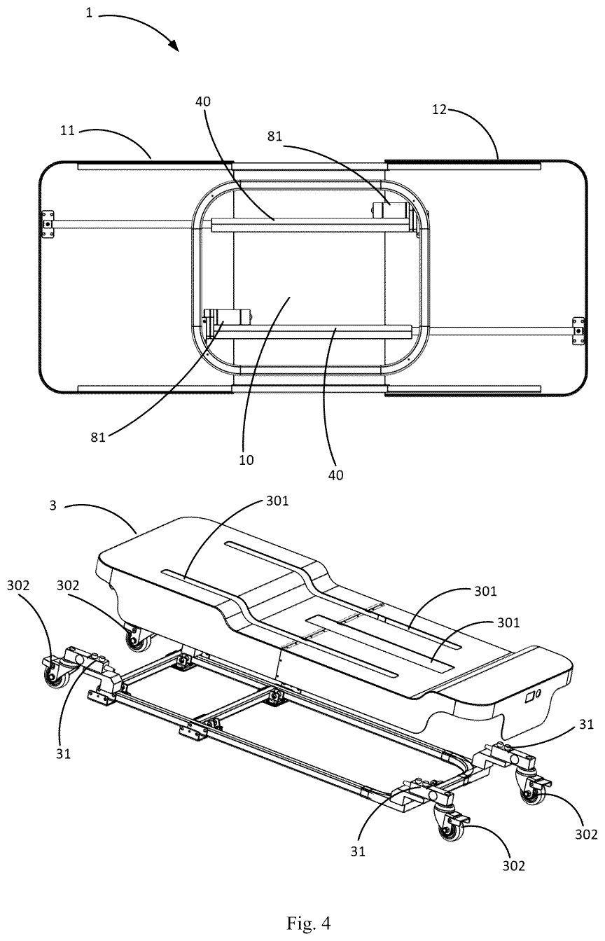

As shown in FIG. 4, the weight sensor 31 is arranged between the rollers 302 and the base 3.

The base 3 is also provided with a plurality of slots 301. The slots 301 are arranged corresponding to the support frames 201 and the telescopic rod 40, and can accommodate the support frames 201 and the telescopic rod 40.

The first driving member 81 may be a manual device. The driving member includes gears and racks. The second retractable platform 12 is pulled/pushed by the driving device as the first retractable platform 11 is pulled or pushed.

The first driving member 81 may be an automatic device. The driving member includes gears, racks and motors. The driving device drives the first retractable platform 11 and the second retractable platform 12 to extend or retract.

As shown in FIG. 4, the first driving member 81 includes the telescopic rods 40, pushing or retracting the first retractable platform 11 and the second retractable platform 12.

The first retractable platform 11 and the second retractable platform 12 can be extended or retracted separately.

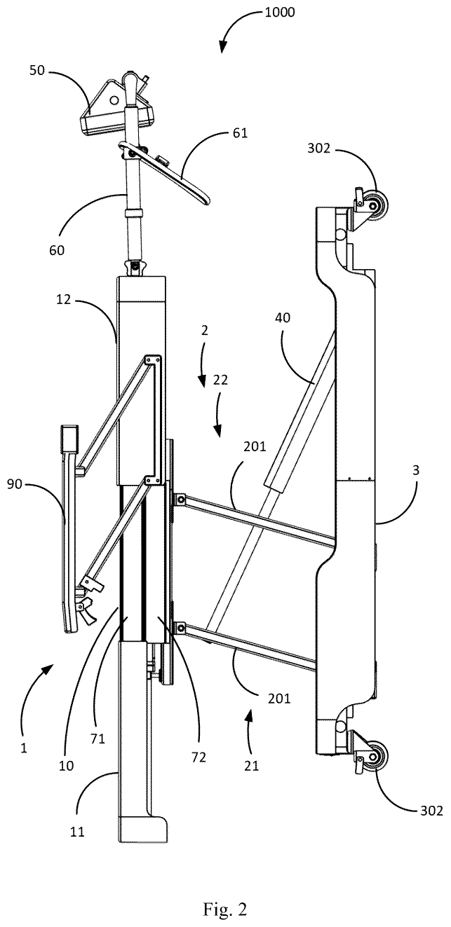

Furthermore, a retractable multi-shaped scale 1000, as shown in FIG. 2, includes a telescopic handle frame 60 connected to the second retractable platform 12. The telescopic handle frame 60 includes a backing plate 61, and the backing plate 61 can be adjusted to the subject's back to provide support for the subject when the scale is in a sitting position. When the scale is in a lying position, the backing plate 61 can be adjusted to the subject's head to support the subject's head. The telescopic handle frame 60 can be folded vertically or horizontally (or different angles) on the retractable part 1 and fixed with a knob 62, and the length of the telescopic handle frame 60 can be adjusted.

As shown in FIG. 2, the retractable part 1 further includes an armrest 90 connected to two corresponding sides of the second retractable platform 12 for the subject to lean on or apply force to.

The operation panel 50 can be installed on the telescopic handle frame 60 or the armrest 90.

A retractable multi-shaped scale 1000, another embodiment of the retractable part 1 includes a retractable part 1, the retractable part 1 includes a fixed platform 10, the fixed platform 10 includes a first internal space, two opposite inner sides of the first internal space are provided with a first rail 71 and a second rail 72 respectively, the first rail 71 is parallel to the second rail 72; a second retractable platform 12, the second retractable platform 12 includes a second internal space, the outside dimensions of the second retractable platform 12 are slightly smaller than the first internal space, two outer sides of the second retractable platform 12 corresponding to the second rail 72 are provided with a slide rail 73 respectively, the second retractable platform 12 is located in the first internal space, and the second retractable platform 12 can slide in the first internal space through the second rail 72 and the slide rail 73; a first retractable platform 11, the outside dimensions of the first retractable platform 11 are slightly smaller than the second internal space. Two outer sides of the first retractable platform 11 corresponding to the first rail 71 are provided with the slide rail 73 respectively. The first retractable platform 11 is located in the second internal space. The first retractable platform 11 can be extended or retracted through the first rail 71 and the slide rail 73.

### Embodiment 1

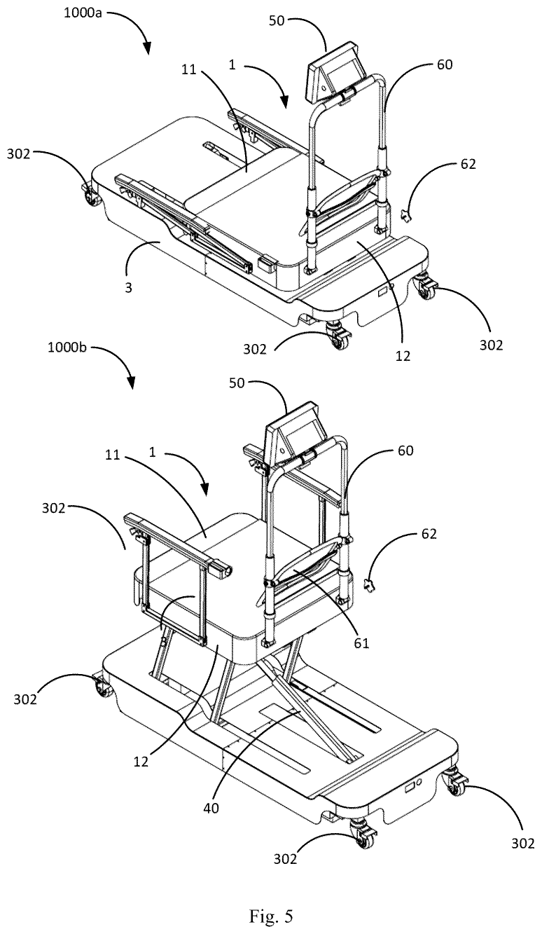

A retractable multi-shaped scale is used in a standing position 1000a, and the retractable part 1 is manual, as shown in FIG. 5, the method includes: A10. a user pushes a first retractable platform 11 and a second retractable platform 12 of a retractable part 1 to a fixed platform 10 to close it; A20. Furthermore, the retractable part 1 is pressed to a base 3 to retract a telescopic rod 40 to the shortest length and minimize the distance between the retractable part 1 and the base 3; A30. a telescopic handle frame 60 is folded vertically over the retractable part 1 and secured using a knob 62, and the user can push the telescopic handle frame 60 to move the scale to a subject; A40. The plurality of rollers 302 of the base 3 are fixed, so that the scale is stably fixed on the ground; A50. The subject stands on the retractable part 1 of the scale, the retractable part 1 transmits the subject's weight to at least one weight sensor 31 of the base 3, and the weight sensor 31 transmits the sensed weight to the operation panel 50.

Among the above, A50. It can also be A50a. The subject stands on the base 3 of the scale, and the base 3 transmits the subject's weight to at least one weight sensor 31, and the weight sensor 31 transmits the sensed weight to an operation panel 50.

The operation panel 50 includes a wireless module that can transmit the measured weight to the database.

### Embodiment 2

A retractable multi-shaped scale is used in a sitting position 1000b, and the retractable part 1 is automatic, as shown in FIG. 5, the method includes: B10. a user chooses a sitting position on an operation panel 50, the operation panel 50 sends signals to inform the first driving member 81 to retract the first retractable platform 11 and the second retractable platform 12 to a fixed platform 10; B20. The operation panel 50 sends a signal to notify a second driving member 82 to extend a telescopic rod 40 to the set thes sitting position, ensuring that the distance between the retractable part 1 and a base 3 is suitable for sitting (e.g., 35 to 45 cm). B30. a telescopic handle frame 60 is folded vertically over the retractable part 1 and secured using a knob 62, and the user can push the telescopic handle frame 60 to move the scale to a subject; B40. The plurality of rollers 302 of the base 3 are fixed, so that the scale is stably fixed on the ground; B50. The subject sits on the retractable part 1 of the scale, the retractable part 1 transmits the subject's weight to at least one weight sensor 31 of the base 3, and the weight sensor 31 transmits the sensed weight to the operation panel 50.

The telescopic handle frame 60 includes a backing plate 61, the backing plate 61 can be adjusted to the subject's back for the subject to lean on.

### Embodiment 3

A retractable multi-shaped scale is used in a lying position 1000c, the method includes: C10. a user chooses a lying position on an operation panel 50, the operation panel 50 sends signals to inform the first driving member 81 to extend a first retractable platform 11 and a second retractable platform 12 to both sides of a fixed platform 10; C20. The operation panel 50 sends signals to inform a second driving member 82 to extend a telescopic rod 40 to the set length for the lying position, so that the retractable part 1 is as high as the bed (for example, 50˜60 cm); C30. a telescopic handle frame 60 is parallel to the retractable part 1 and fixed with a knob 62, and the user can push the telescopic handle frame 60 to move the scale to a subject; C40. The plurality of rollers 302 of the base 3 are fixed, so that the scale is stably fixed on the ground; C50. The user moves the subject to the retractable part 1 of the scale, the retractable part 1 transmits the subject's weight to at least one weight sensor 31 of the base 3, and the weight sensor 31 transmits the sensed weight to the operation panel 50.

A backing plate 61 of the telescopic handle frame 60 is adjusted to the subject's head to support the subject's head.

A mat can be provided to make the subject more comfortable when lying down before the user moves the subject to the retractable part 1 of the scale.

To respond to different circumstances, separate extension or retraction of the first retractable platform 11 and the second retractable platform 12 of the retractable part 1 can be set up on the operation panel 50.

To store the retractable multi-shaped scale 1000, a storage pattern can be selected on the operation panel 50, the retractable part 1 retracts the first and second retractable platforms 11, 12, and the telescopic rod 40 is retracted to its shortest length, so that the distance between the retractable part 1 and the base 3 is minimized. The telescopic handle frame 60 is parallel to the retractable part 1, fixed with the knob 62 and retracted to the shortest length.

### Embodiment 4

A retractable multi-shaped scale 1000, including a retractable part 1, the retractable part 1 includes a fixed platform 10, two opposite sides of the fixed platform 10 are respectively provided with a first rail 71 and a second rail 72; a first retractable platform 11, the first retractable platform can accommodate the fixed platform 10, and can slide along the first rail 71; a second retractable platform 12, the second retractable platform 12 can accommodate the first retractable platform 11, and can slide toward the opposite side of the first retractable platform 11 along the second rail 72; a support part 2, for supporting the retractable part 1 and transmitting the weight, the support part 2 includes a plurality of support frames 201 and a cross bar 202, two ends of the cross bar 202 are connected to a set of corresponding support frames 201, one end of the support frames 201 is pivotally connected to the bottom of the fixed platform 10; a base 3, located at the lower part of the scale, the other end of the support frames 201 is pivotally connected to the base 3, and the base 3 includes at least one weight sensor 31 for obtaining the measurement results; a telescopic rod 40, one end is pivotally connected to the base 3, and the other end is pivotally connected to the cross bar 202. The telescopic rod 40 is used to drive the support frames 201 from horizontal to vertical, and to change the distance between the base 3 and the retractable part 1; and an operation panel 50, the operation panel 50 is connected to the weight sensor 31 to display the measurement results of the weight sensor.

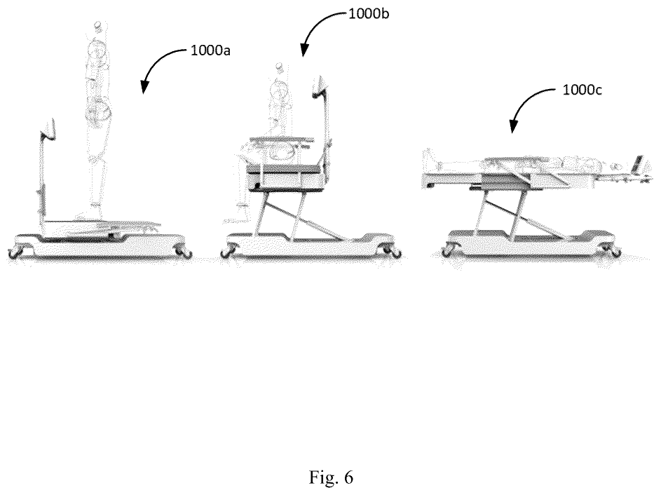

To sum up, the present invention provides a retractable multi-shaped scale 1000 that can change its shape in response to different situations. FIG. 6 shows the standing pattern 1000a, sitting pattern 1000b, and lying pattern 1000c, allowing the user to measure weight in a standing, sitting or lying position. For bedridden patients, the weight can be measured without moving the patients. The elderly and the disabled can measure weight in a sitting or lying position. Normal people can measure weight in a standing position. When the weight is measured in a sitting or standing position, the armrest 90 provides support and assistance to prevent the user from falling due to instability, so as to improve the work efficiency of medical staff and reduce the labor burden and psychological pressure of the patients' family and caregivers. For hospitals, it is unnecessary to spend money on purchasing bed scales, sitting scales, upright scales and other equipment at the same time, and the retractable multi-shaped scale 1000 of the present invention can be reduced in size and placed under the bed, it is easy to store and portable, reducing the waste of space.

1. A retractable multi-shaped scale, including a retractable part, the retractable part includes a fixed platform, two opposite sides of the fixed platform are respectively provided with a first rail and a second rail; a first retractable platform, the first retractable platform can accommodate the fixed platform, and can slide along the first rail; a second retractable platform, the second retractable platform can accommodate the first retractable platform, and can slide toward the opposite side of the first retractable platform along the second rail; a support part, for supporting the retractable part and transmitting the weight, the support part includes a plurality of support frames and a cross bar, two ends of the cross bar are connected to a set of corresponding support frames, one end of the support frames is pivotally connected to the bottom of the fixed platform; a base, located at the lower part of the scale, the other end of the support frames is pivotally connected to the base, and the base includes at least one weight sensor for obtaining the measurement results; a telescopic rod, one end is pivotally connected to the base, and the other end is pivotally connected to the cross bar, the telescopic rod is used to drive the support frames from horizontal to vertical, and to change the distance between the base and the retractable part; and an operation panel, the operation panel is connected to the weight sensor to display the measurement results of the weight sensor.

2. The retractable multi-shaped scale defined in claim 1, wherein the inner space of the first retractable platform is slightly larger than the size of the fixed platform, two inner sides of the first retractable platform corresponding to the first rail of the fixed platform are provided with a slide rail, the inner space of the second retractable platform is slightly larger than the size of the first retractable platform, two inner sides of the second retractable platform corresponding to the second rail of the fixed platform are provided with the slide rail.

3. The retractable multi-shaped scale defined in claim 1, wherein the telescopic rod is connected to a second driving member, which in turn is connected to the operation panel capable of setting the extension length of the telescopic rod.

4. The retractable multi-shaped scale defined in claim 1, wherein the retractable part also includes a first driving member installed inside the fixed platform, which can extend or retract the first retractable platform and/or the second retractable platform.

5. The retractable multi-shaped scale defined in claim 4, wherein the first driving member includes the telescopic rods, which, controlled by the operation panel, drive the first retractable platform and/or the second retractable platform to extend or retract.

6. The retractable multi-shaped scale defined in claim 4, wherein the first driving member includes gears and racks, by pulling/pushing the first retractable platform, the second retractable platform is interlinked to be pulled/pushed accordingly.

7. The retractable multi-shaped scale defined in claim 1, wherein the base is also provided with a plurality of slots, the slots are arranged corresponding to the support frames and the telescopic rod.

8. The retractable multi-shaped scale defined in claim 1, wherein the scale further includes a telescopic handle frame connected to the second retractable platform, the telescopic handle frame can be folded at different angles over the retractable part.

9. The retractable multi-shaped scale defined in claim 1, wherein the retractable part further includes an armrest connected to two corresponding sides of the second retractable platform.

10. The retractable multi-shaped scale defined in claim 1, wherein the base also includes a plurality of rollers, the weight sensor is arranged between the rollers and the base.
